(19) United States
(12) Patent Application Publication
(10) Pub. No.: US 2017/0189868 A1
(43) Pub. Date: Jul. 6, 2017

(54) Automated Liquid Blending System

(71) Applicant: KSi Conveyor, Inc., Sabetha, KS (US)

(72) Inventors: Dominic E. Meyer, Sabetha, KS (US); Matthew Edelman, Sabetha, KS (US); Ronnie J. Edelman, Sabetha, KS (US)

(73) Assignee: KSi Conveyor, Inc., Sabetha, KS (US)

(21) Appl. No.: 15/399,569

(22) Filed: Jan. 5, 2017

Related U.S. Application Data
(60) Provisional application No. 62/275,327, filed on Jan. 6, 2016.

(51) Int. Cl. B01F 3/08; B01F 15/02; B01F 15/04; B01F 15/00

(52) U.S. Cl. CPC B01F 3/088; B01F 3/0869; B01F 15/00142; B01F 15/00311; B01F 15/0243; B01F 15/0416; B01F 15/0429; B01F 15/00194; B01F 2215/0009; B01F 2215/0055

(57) ABSTRACT

A liquid blending system and method for the continuous blending of agrochemicals. The system uses static-rate pumps to deliver a continuous pressurized agrochemical to the proportional valve and the control system continuously regulates the flow rate by controlling the respective proportional valve. A method is disclosed for the simultaneous delivery of the requested quantity of each respective agrochemical. Each agrochemical flow rate is adjusted to deliver the requested quantity of each agrochemical fluid simultaneously based on a measured quantity of each agrochemical fluid as a proportion of the total quantity of the respective agrochemical fluid requested based on a blend recipe; a selected blend recipe; and a measured rate-limiting liquid source. A modular rack system is described for organizing and efficiently installing and maintaining the system.

### CROSS REFERENCES

This application claims the benefit of U.S. Provisional Application No. 62/275,327, filed 6 Jan. 2016.

### REFERENCE TO CDs

Not Applicable.

### BACKGROUND

Many industries need to produce accurate blends of two or more liquids. It is often important that a minimal amount of liquid be wasted or left behind as residue in the blending system. These concerns are increased in the preparation of agrochemicals such as fertilizers and pesticides, as the waste produced from the cleaning out the residual liquid needs to be disposed in accordance with strict regulations.

### SUMMARY

The present invention is directed to an apparatus that satisfies the need to produce an accurate blend of product at high flow rates and produces minimal residual waste. The apparatus comprises two or more liquid sources. A fluid pump, flow meter, and liquid flow regulator are connected to each liquid source. The liquid sources are combined at a fluid manifold. The fluid manifold is connected to a static mixer, where the various liquids are blended together. The fluid manifold is connected to a delivery coupling, for dispensing the blended liquid into a receptacle. A control system 100 is electrically coupled to the flow meters and liquid flow regulators. The control system 100 is configured to receive an electrical signal generated by each flow meter. The control system 100 is also configured to generate an electric control signal to control the respective flow regulators in response to a recipe.

This disclosed automated liquid blend system produces accurately blended product at high flow rates with minimal amounts of waste product. The automated liquid blend system disclosed utilizes flow regulators to control the rate of liquid flow near the point of delivery, which allows the system to rapidly react to changes in liquid flow. The system is also capable of simultaneously delivering individual liquids at full speed into a mixing point, thereby reducing the processing time. Another advantage of the current disclosure is the elimination of a separate mixing tank, which saves time, expense, and waste.

The use of flow regulators—such as pneumatically or electronically controlled proportional valves—allows for the rate control device to be placed near the point of mixing and delivery. This is advantageous over the use of variable rate pumps, since variable rate pumps generally need to be located nearer the liquid source.

This innovation simultaneously delivers and blends multiple liquids into a single stream. This is advantageous over existing liquid blend systems that bring in individual liquids at full speed into a single mixing vessel. Such systems utilize blending methods that typically require 20 minutes or more to process a 260 gallon shuttle of blended product. This innovation simultaneously delivers the required individual ingredient liquids while mixing and delivering the blended product directly into the final product shuttle. One embodiment of this system and method was able to process a 260 gallon shuttle in only 7 minutes.

Another advantage of the current innovation is removing the requirement for separate mixing tank. Eliminating a separate mixing tank saves time and expense. Removing the mixing tank also eliminates the time and expense of flushing the separate mixing tank. The residual product in a separate mixing tank is substantially more than the residual product in the liquid connections from the manifold to the delivery shuttle in the innovation described here.

This innovation could be implemented in a variety of technology fields that blend liquids according to specific recipes. This innovation is specifically useful to create a liquid blend from a recipe that utilizes liquid sources having different viscosities. This innovation is also specifically useful when one or more of the blended liquids contains a controlled or hazardous substance, such as a pesticide, herbicide, or fertilizer.

It is understood that other embodiments will become readily apparent to those skilled in the art from the following detailed description, wherein various embodiments are shown and described by way of illustration only. As will be realized, the concepts are capable of other and different embodiments and their several details are capable of modification in various other respects, all without departing from the spirit and scope of what is claimed as the invention.

Accordingly, the drawings and detailed description are to be regarded as illustrative in nature and not as restrictive.

### BRIEF DESCRIPTION OF DRAWINGS

Aspects are illustrated by way of example, and not by way of limitation, in the accompanying drawings, wherein:

FIG. 1 depicts a modular control station for liquid blending and the delivery shuttle;

FIG. 2 shows a flow chart of the fluid connections (in double lines) and the electrical data/control connections of an embodiment of the liquid blending system.

FIG. 3 shows a diagram of a simplified embodiment of the liquid blending system having two liquid sources;

FIG. 4 shows a diagram of the pneumatic connections of the simplified embodiment of the liquid blending system of FIG. 3;

FIG. 5 shows a flow chart of the control system process for optimizing target rates for a blend recipe and continuously tuning the delivery ratios to ensure even completion time and mix efficiency.

### DETAILED DESCRIPTION

As noted above, this automated liquid blending system overcomes numerous problems, such as low flow rates and residual waste of the blended product.

We disclose a system that has a plurality of liquid sources 10. The liquid sources can contain solutions of individual active ingredients or solutions with a predetermined mix of ingredients. Each liquid source 10 has a fluid connection for connecting the fluid source to a pump. For example, the liquid source 10 can have a connection such as a MicroMatic keg valve or camlock fitting.

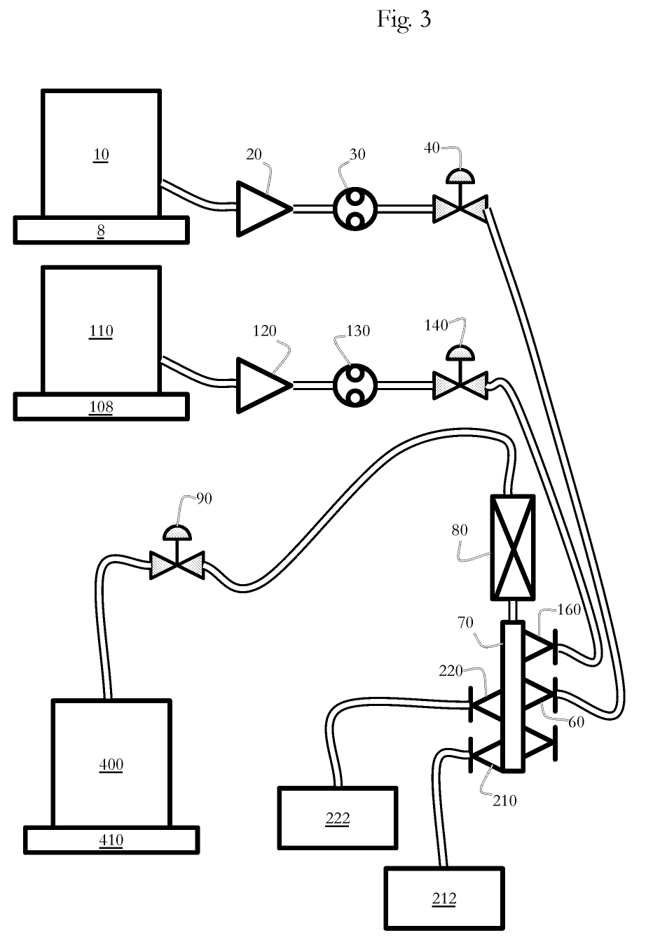

In one embodiment, such as the liquid blending system shown in FIG. 3, each liquid source 10, 110 has a scale 8, 108. The scale provides an electric signal relative to the mass of respective liquid source 10. In another embodiment, a mass flow meter (not shown) is in fluid communication with each liquid source 10. The use of a mass flow meter to generate an electric signal relative to the mass of the liquid flow is known in the art.

A pump 20 is in fluid communication with each liquid source. The pump is preferably an air operated, double diaphragm pump. The double diaphragm air pump is advantageous because it can hold a constant pressure on the fluid line without compromising the pump. As liquid pressure builds, the pump slows down until the liquid pressure drops. The pump remains energized and the fluid remains pressurized. The pump can maintain a potential liquid flow rate without negatively affecting pump.

The pump must have sufficient pressure capabilities to satisfy the plumbing requirements of the system. The pressure requirements are based on the plumbing arrangement. The pressure drops through tubing, check valves, and across the static mixer.

A flow meter 30 is in fluid communication with each liquid source. The flow meter 30 could be a volumetric flow meter or a mass flow meter. An example of a volumetric flow meter is a magnetic flow meter. Volumetric flow meters must be calibrated for each product that is put through it. The flow meter 30 provides an individual flow rate signal corresponding to the flow rate for each product. The control system 100 is configured to receive each individual flow rate signal.

The flow meter 30 generates a flow rate signal for each liquid source product. In one embodiment, the flow meter 30 generates an analog electric signal corresponding to the flow rate for each product. The flow meter 30 is in electric communication with the control system 100.

In one embodiment, the flow meter 30 is a mass flow meter. The use of mass flow meters to determine the flow rate of a liquid are known in the art. The mass flow meter would be advantageous to eliminate the calibration step for the volumetric flow meter. In one embodiment, the meter used to generate the flow signal is a mass meter—such as a scale with a load cell—that receives the fluid source container. The mass meter generates a mass signal. The control system 100 is configured to calculate a flow rate based on a loss-in-weight calculation of the change in mass signal over a time interval.

A liquid flow regulator 40 is in fluid communication with each liquid source. The liquid flow regulator provides control over the flow rate of the product. In one embodiment, the control system 100 sends an analog control signal that is received by the liquid flow regulator 40. The liquid flow regulator responds proportionately. For example, the liquid flow regulator can comprise an electro-pneumatic valve, which converts analog electric signal to pneumatic control over the valve, thereby affecting the flow rate. The liquid flow regulator 40 is positioned downstream from flow meter 30 because the regulator causes the flow of the liquid to be turbulent.

In one embodiment, the liquid flow regulator 40 is comprised of teflon to increase compatibility with a variety of products.

The liquid blending system can be described as having respective fluid handling assemblies for each fluid sources containing agrochemicals. Each fluid handling assembly comprises a static-rate pump for each fluid source. Each fluid handling assembly has an inlet fluid connection for connecting to a respective fluid source and an outlet fluid connection for directing a first pressurized fluid. Each fluid handling assembly comprises a meter that generates a fluid signal in relation to the amount of the fluid flowing from the fluid source. Each fluid handling assembly also comprises a proportional valve fluidly connected downstream of the meter, the proportional valve biased in a closed position.

Each proportional valve receives the respective control signal; and each proportional valve opens in response to the respective control signal whereby a desired flow rate of each fluid is continuously delivered to a downstream mixing assembly.

A liquid manifold 70 is in fluid communication with each liquid source. The liquid manifold 70 is a chamber for receiving multiple liquid source connections. For example, the liquid manifold 70 could be an aluminum manifold with multiple ports. The function of the liquid manifold 70 is to combine the multiple fluid sources into a single output. The liquid manifold 70 has a plurality of inlet ports to allow connections from a plurality of liquid sources.

Preferably, the liquid manifold 70 is oriented vertically, with output flow out the top. In making the fluid connections between the liquid sources and the manifold, the higher rate sources are connected into bottom, lower rate product in through the top. In other words, the higher rate liquid connections are located furthest from the discharge point and the lower rate liquid connections are located closer to the discharge point. This allows the higher rate liquid product flow to carry the lower rate liquid through the liquid manifold 70.

A one-way check valve 60 is in fluid communication with each liquid source. Preferably, the check valves 60 are connected immediately before the liquid source is connected to the manifold 70. The check valves 60 prevent liquid back-flow. This allows the system to avoid cross contamination from one recipe to another. In a preferred embodiment, the check valves 60 are self-sealing, non-reactant and not dependent on gravity, mounting position, or reverse flow.

A mixing assembly having a static mixer 80 is in fluid communication with the liquid manifold 70. The static mixer 80 can be an inline static mixer which creates a mixing action as the liquid moves through the static mixer. The static mixers incorporate a turbulence-inducing mixing element in the liquid flow path. These turbulence-inducing mixing elements can have specific shapes and sizes—such as a blade, helix, or wafer—to efficiently cause the liquids to blend. The specific design of the static mixer would depend on the characteristics of the liquids to be blended in a specific application.

In a preferred embodiment, the static mixer 80 is oriented vertically. Liquid flows up through the static mixer. The vertical orientation is advantageous because the liquid flow can vary. It is important that the liquid does not merely trickle through the static mixer. The vertical orientation—with liquid entering through the bottom—assures that liquid only progresses through the static mixer 80 when the volume of the static mixer is full of liquid. This is especially important when the fluid sources have different characteristics, such as differing solubility or viscosity characteristics which could result in the various liquids layering. Passing through the static mixer 80 allows even stiff, gel-like fluids to be broken apart and blended with other fluids.

A shutoff valve 90 is in fluid communication with the blended liquid source upstream of the discharge point. The shutoff valve 90 can be pneumatic powered. The shutoff valve 90 can be electrically connected to Control system 100, allowing the system to control the operation of the shutoff valve 90. Preferably, the shutoff valve 90 can be operated by activating the E-stop.

A delivery coupling is in fluid communication with the blended liquid source at the discharge point. The delivery coupling allows a fluid connection to the delivery vessel. The coupling can have a connection such as a micromatic coupler or cam lock fitting.

An air purge valve 210 is connected to the liquid manifold 70. The air purge valve 210 can be opened to provide a flow of compressed air from a compressed air source 212 to purge residual fluid at the end of the blending delivery cycle. Substantially all liquid product needs to be removed from the manifold and downstream of the manifold. The air purge forces liquid through liquid connections into the shuttle. This provides the customer with a complete delivery of product and also provides an initial cleaning of the blended product. The air purge provides a medium that naturally separates from the blended liquid product. The control system 100 can be programmed to automatically trigger the air purge at the end of blending delivery cycle.

A solvent purge valve 220 is also connected to the liquid manifold 70. The solvent purge valve 220 can be opened to provide a flow of pressurized solvent from a pressurized solvent source 222 to purge residual fluid at the end of the blending delivery cycle and after the air purge. The solvent purge flushes residual fluid from the system. Generally, this waste solvent mixture must be collected and disposed of. The air purge step minimizes the amount of solvent necessary to clear the system of residual liquid. In one embodiment, the solvent used is water. The control system 100 can be programmed to automatically trigger the solvent purge at the end of blending delivery cycle and after the air purge.

The blended liquid is delivered into a delivery shuttle 400. The delivery shuttle 400 is a liquid container that receives the blended liquid. In one embodiment, the delivery shuttle 400 is a one-time use receptacle. The delivery shuttle 400 can be sized as appropriate for the quantity of liquid desired by the customer. In one embodiment, the delivery shuttle is a 260-gallon container. In another embodiment, the delivery shuttle 400 can be a standard 5-gallon bucket. In one embodiment, the delivery shuttle 400 is positioned on a scale 410 for measuring the mass of blended liquid delivered into the delivery shuttle 400.

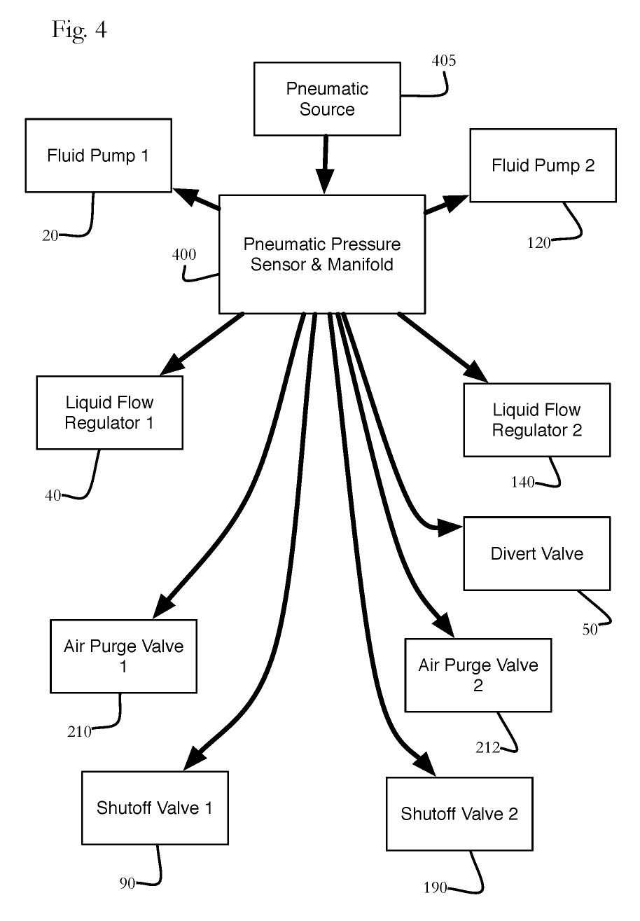

As shown in FIG. 4, a pneumatic source 405 is connected to a pneumatic pressure sensor and manifold 400. The pneumatic sensor and manifold 400 provides pneumatic pressure from the pneumatic source to each of the pumps, valves, and regulating proportional valves.

Advantages of the current disclosure include:
a) elimination of chemical contamination and cross contamination between recipe specifications;
b) The delivery shuttle 400 requires no agitation since the liquid enters the shuttle in a blended mixture.

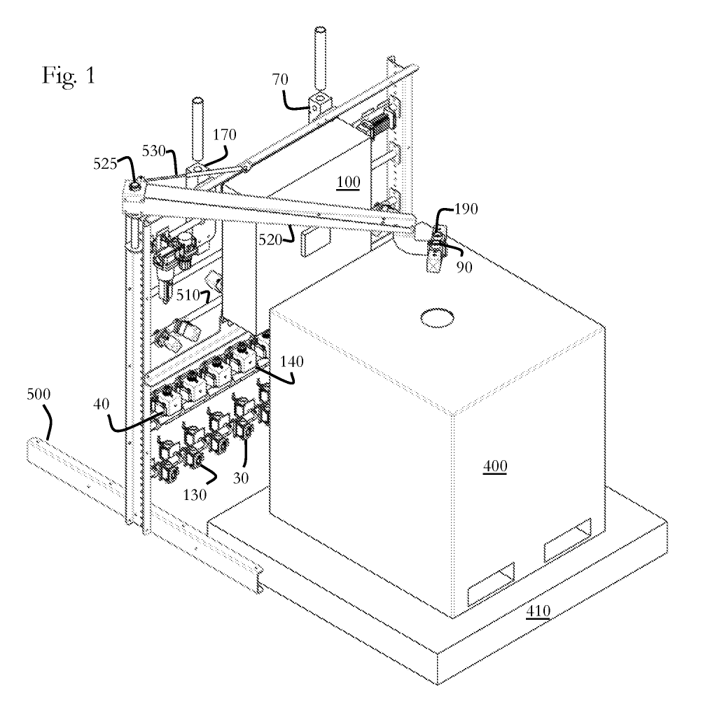

In one embodiment, a liquid control center provides a structure 500 for mounting certain of the components of the liquid blend system that are controlled by the control system 100. For example, FIG. 6 shows an embodiment of the liquid control center providing a structure 500 for mounting the control system 100, the flow meters, the flow regulators, the manifold, and the static mixer. This embodiment also provides structure for mounting the HMI interface 105 with the control system 100. The liquid control center provides a plurality of horizontal support bars 510. The support bars allow the mounting of a variety of components, such as the control system 100, flow meters, flow regulators, manifold, static mixer. The structure 500 illustrated in FIG. 1 is a representation of a modular control station comprising several horizontal support bars 510 providing a first elongated member mounted to the structure for mounting each flow regulating valve and a second elongated member mounted to the station for mounting each flow meter. An elongated arm 520 positions the discharge point above the fluid connection of the delivery shuttle 400. The elongated arm 520 is pivotally mounted to the structure 500. The control system 100 can be configured to pivot the elongated arm 520 using an actuator 530, such that the elongated arm is pivoted toward the control system 100 at the end of a blending cycle. The elongated arm 520 pivots about a pivot joint 525.

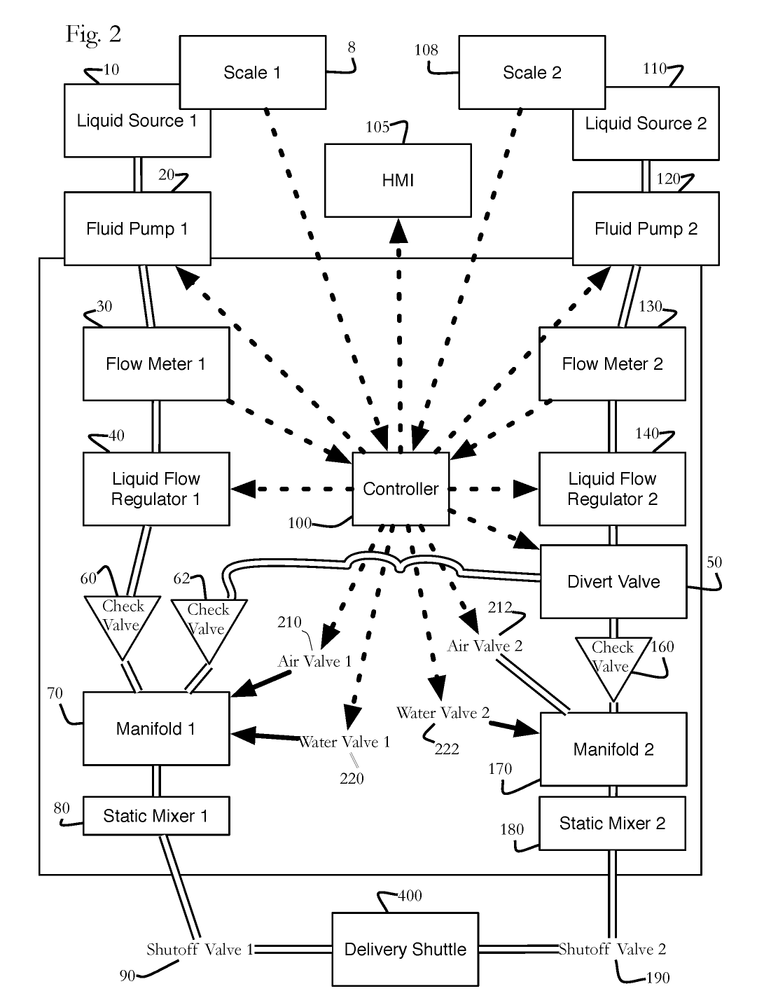

As shown in FIG. 2, the control system 100 receives each fluid signal and each scale signal. The control system is in electric communication with the various air valves, liquid flow regulators (proportional valves), and each of the static-rate fluid pumps. The control system generates a control signal for each proportional valve based on the respective fluid signal and a blending recipe. Each proportional valve receives the respective control signal opens in response to the respective control signal whereby a desired flow rate of each fluid is continuously delivered to a downstream mixing assembly.

The modular system is designed to accommodate multiple liquid sources, in some embodiments of the modular system there are between 6 to 20 liquid sources. Certain figures illustrate a second set of equipment for a second liquid source. The respective elements are labeled as follows: a second static-rate pump 120, a second fluid meter 130, a second proportional valve 140; a second check valve 160; a second liquid manifold 170; a second static mixer 180; second air purge valve 212; a second water valve 222; a second shutoff valve 190. Optionally, a divert valve 50 can be in fluid communication with each liquid source. The divert valve 50 can provide isolation between two different liquid paths to isolate certain products from the liquid path for other products. A third check valve 62 is disposed between the outflow of the divert valve and the first manifold 70. The divert valve can provide certain liquid sources to blend into otherwise isolated fluid paths.

Optionally, the system is optimized to increase the continuous production of the blended fluid. The control system 100 continuously tunes the flow-rate for each respective proportional valve to coordinate the completion of the each component liquid at the same time. The control system is configured to store the measured flow rate for specific fluid sources under actual flow conditions in accordance with a range of control signals. During a subsequent control cycle, the control system compares the flow rate of a selected blend recipe with the stored flow rates and selects the control signal that corresponds closest to the flow rate of the selected blend recipe. This tuning process can also occur during a cycle. For example, the control system 100 calculates that 50% of Fluid #1 has been dispersed and 45% of Fluid #2 has been dispersed. The control system 100 may be configured to record the measured flow rate for each fluid source that corresponds with the control signal. The control system 100 may be configured to decrease the flow rate of Fluid #1 by decreasing the respective control signal. The control system 100 may access the stored flow rate and control signal database, to select the control signal that corresponds closest to the flow rate of the selected blend recipe.

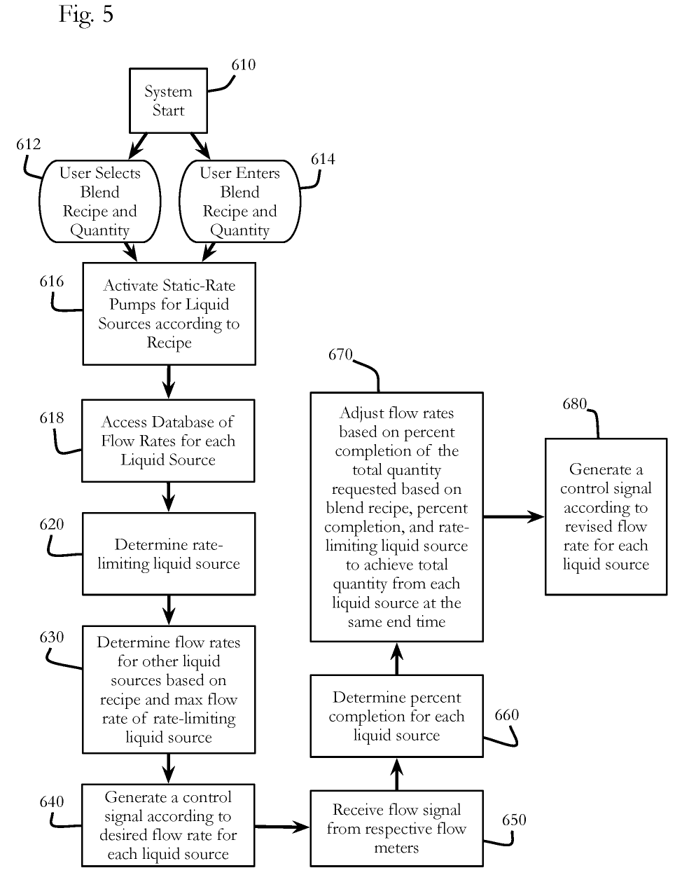

FIG. 5 is a flow chart for the control system 100 operation to optimize target rates for batch sizes and to adjust the real-time blend rate to complete the delivery of all liquids simultaneously. On System Start (as shown in step 610), the user selects the blend recipe and quantity (as shown in step 612) or the user enters a blend recipe and quantity (as shown in step 614). The control system activates the static-rate pumps for liquid sources according to the selected or entered recipe (as shown in step 616). The control system accesses a database of flow rates for each liquid source (as shown in step 618). The control system determines the rate-limiting liquid source based on the blend recipe and the recorded flow rates (as shown in step 620). The control system determines the flow rates for the other liquid sources based on the recipe and the max flow rate of the rate-limiting liquid source (as shown in step 630). The control system generates a control signal according to the desired flow rate for each liquid source (as shown in step 640). The control system continuously receives flow signal measurements, which the control system can use to update the flow rate database. The control system then receives a flow signal from respective flow meters (as shown in step 650). The control system then determines percent completion for each liquid source (as shown in step 660) based on the flow signal. For example, the system can calculate the total amount of each fluid delivered based on the flow signal and elapsed time. The control system then determines the percent completion for each liquid source (as shown in step 660). The control system then adjusts each flow rate based on percent completion of the total quantity requested based on blend recipe, percent completion, and rate-limiting liquid source to achieve total quantity from each liquid source at the same end time (as shown in step 670). The control system 100 then generates a control signal according to the revised flow rate for each liquid source (as shown in step 680). For example, if the system has dispensed 50% of the first fluid and only 45% of the second fluid, the system adjusts the flow rates such to increase the flow rate of the second fluid relative to the first fluid. The control system generates a control signal according to the revised flow rate for each liquid source. The control system may run Steps 650, 660, 670, and 680 multiple times during the a blending cycle.

It is possible to implement the current disclosure into industries including seed treatment; fertilizer preparation; crop care. In one embodiment, we disclose an automated system for blending fluid comprising:
a plurality of liquid sources;
a plurality of fluid pumps, each fluidly connected to a respective liquid source;
a plurality of flow meters, each fluidly connected to a respective liquid source downstream of a fluid pump and capable of providing an electrical signal corresponding to the flow rate of the respective liquid source;
a plurality of liquid flow regulators, each fluidly connected to a respective liquid source downstream of a flow meter;
a first fluid manifold fluidly connected to at least two of the plurality of liquid sources;
a first static mixer fluidly connected to the first fluid manifold;
a first fluid delivery coupling fluidly connected to the first fluid manifold for delivering the metered, blended fluid into a receptacle; and
a control system 100 electrically coupled to the plurality of flow meters and the plurality of liquid flow regulators, the control system 100 configured to receive the electrical signal generated by each flow meter and generate an electric control signal to control the respective flow regulator in response to a recipe.

As shown in FIG. 2, we disclose an automated system that further comprises two or more fluid manifolds 70, 170. Certain fluid sources are fluidly connected only to a first manifold. Other fluid sources are fluidly connected only to a second manifold. Other fluid sources are fluidly connected to the first and the second manifolds. A diverter valve 50 can be employed to facilitate the fluid connection to more than one manifold. The use of multiple manifolds can provide isolation between two different liquid paths to isolate certain liquid products from the liquid path for other products. The divert valve can provide certain liquid sources to blend in otherwise isolated fluid paths.

In another embodiment, we disclose an automated system for blending liquids comprising:
a liquid control center having a plurality of liquid connections providing fluid communication to the seed treatment applicator;
a plurality of fluid connections fluidly connected to one of the plurality of liquid connections of the liquid control center;
a plurality of fluid couplings for fluidly connecting one of the plurality of fluid connections to a seed treatment fluid source;
a plurality of pumps operably connected to the fluid connection between a respective fluid coupling and the seed treatment applicator;
a plurality of flow control valves fluidly connected to the fluid connection between respective pump and the seed treatment applicator for controlling the rate at which a respective seed treatment fluid flows;
a plurality of metering devices for generating a signal relative to the flow rate of the respective seed treatment fluid;
a control system 100 electrically coupled to the static pump, the control system 100 configured to receive a weight reading from the scale, the control system 100 further configured to selectively operate the flow regulator in response to a recipe.

It is understood that other embodiments will become readily apparent to those skilled in the art from the following detailed description, wherein various embodiments are shown and described by way of illustration only. As will be realized, the concepts are capable of other and different embodiments and their several details are capable of modification in various other respects, all without departing from the spirit and scope of what is claimed as the invention. Accordingly, the drawings and detailed description are to be regarded as illustrative in nature and not as restrictive.

We claim:

1. A liquid blending system for the continuous blending of fluids for agricultural uses, the liquid blending system comprising:
a. A fluid handling assembly for each of two or more bulk fluid sources containing agrochemicals, each fluid handling assembly comprising:
i. A static-rate pump comprising:
1. A inlet fluid connection for connecting to a respective fluid source; and
2. A outlet fluid connection for directing a first pressurized fluid;
ii. A meter that generates a fluid signal in relation to the amount of the fluid flowing from the fluid source;
iii. A proportional valve fluidly connected downstream of the meter, the proportional valve biased in a closed position;
b. A control system that receives each fluid signal, the control system generates a power signal to activate a respective static-rate pump, and the control system generates a control signal for each proportional valve based on the respective fluid signal and a blending recipe;
c. Each proportional valve receives the respective control signal; and each proportional valve opens in response to the respective control signal whereby a desired flow rate of each fluid is continuously delivered to a downstream mixing assembly;
d. Wherein each static-rate pumps delivers a continuous pressurized agrochemical to the proportional valve and the control system continuously regulates the flow rate using the respective proportional valve.

2. The system of claim 1, wherein the static-rate pump is a high flow rate pump for fluid sources that make up a greater proportion of the blend recipe; and the static-rate pump is a low flow rate pump for fluid sources that make up a smaller proportion of the blend recipe.

3. The system of claim 1, wherein the control system is further configured to store the measured flow rate for a range of control signals; and the control system compares the flow rate of a selected blend recipe with the stored flow rates and selected the control signal that corresponds closest to the flow rate of the selected blend recipe.

4. The system of claim 3, wherein the meter is a mass meter and generates the fluid signal related to the mass of the fluid discharged from the fluid source.

5. The system of claim 3, wherein the meter is a flow meter positioned upstream of the proportional valve and the flow meter generates the fluid signal related to the volumetric flow rate of the fluid discharged from the fluid source.

6. The system of claim 5, wherein the static-rate pump is an air-operated, double-diaphragm pump.

7. The continuous liquid blending system of claim 5, further comprising:
a. A modular control station structure comprising:
i. A first elongated member mounted to the station for mounting each proportional valve;
ii. A second elongated member mounted to the station for mounting each meter;
iii. An elongated arm that is pivotally attached to the modular control station structure for routing a discharge tube to a discharge point.

8. A method for the continuous blending of two or more agrochemical fluids from respective bulk fluid sources according to a blend recipe, the method comprising:
a. Providing a static-rate pump for pressurizing an agrochemical fluid from a fluid source;
b. Generating a flow signal for each pressurized agrochemical fluid;
c. Regulating each pressurized agrochemical fluid by generating a control signal for each proportional valve based on the respective flow signal and a blend recipe, thereby reducing each pressurized fluid to a desired flow rate for continuously delivering a consistently proportioned quantity of each agrochemical fluid to a single fluid stream;
d. Continuously blending the consistently proportioned quantity of each fluid in a mixing assembly.

9. The method of claim 8, further comprising the steps of:
a. Weighing the blended fluids in a receptacle to determine a final quantity of the blended liquids.

10. The method of claim 8, wherein the step of providing a static-rate pump further comprises the steps of:
a. Providing a high flow rate pump for pressurizing fluids that make up a greater proportion of the continuous blend recipe; and
b. Providing a low flow rate pump for pressurizing fluids that make up a smaller proportion of the continuous blend recipe.

11. The method of claim 8, further comprising the steps of:
a. Storing the measured flow rate for a range of control signals for each agrochemical fluid; and
b. Generating a control signal that corresponds closest to the desired flow rate based on the blend recipe for a subsequent operation.

12. The method of claim 11, wherein the flow signal is generated by a flow meter upstream of the proportional valve and the flow signal relates to the volumetric flow rate of the fluid discharged from the fluid source.

13. The method of claim 12, further comprising the step of:
a. Adjusting each flow signal to deliver the requested quantity of each agrochemical fluid simultaneously based on:
i. a measured quantity of each agrochemical fluid as a proportion of the total quantity of the respective agrochemical fluid requested based on a blend recipe;
ii. a selected blend recipe; and
iii. a measured rate-limiting liquid source.

14. The method of claim 12, wherein the static-rate pump is an air-operated, double-diaphragm pump.

15. A liquid blending system for the continuous blending of agrochemical fluids from two or more fluid containers, comprising:
a. A first fluid source station comprising:
i. A first fluid connection for connecting to a first fluid container;
ii. A first static rate pump fluidly connected to the first fluid connection for generating a first pressurized fluid;
b. A second fluid source station comprising:
i. A second fluid connection for connecting to a second fluid container;
ii. A second static rate pump fluidly connected to the first fluid connection for generating a second pressurized fluid;
c. A first manifold comprising:
i. a first inlet port;
ii. a second inlet port;
iii. a discharge port;
d. A first liquid flow control module that receives the first pressurized fluid from the first fluid source station, comprising:
i. A first flow regulating valve fluidly connected to the first inlet port of the first manifold;
ii. A first flow meter fluidly connected upstream of the first flow regulating valve, the first flow meter generates a first flow rate signal corresponding to the flow rate of the first pressurized fluid;
e. A second liquid flow control module that receives the second pressurized fluid from the first fluid source station, comprising:
i. A second flow regulating valve fluidly connected to a second inlet port of the first manifold;
ii. A second flow meter fluidly connected upstream of the first flow regulating valve, the second flow meter generates a second flow rate signal corresponding to the flow rate of the second pressurized fluid;
f. A control system operably configured to:
i. receive the first flow rate signal and the second flow rate signal;
ii. generate a first control signal to command the opening of the first flow regulating valve in response to the first signal flow rate signal and a recipe;
iii. generate a second control signal to command the opening of the second flow regulating valve in response to the second signal flow rate signal and the recipe;
g. wherein the control system is further configured to continuously adjust the first control signal and second control signal in response to the first flow rate signal and second flow rate signal, respectively.

16. The continuous liquid blending system of claim 15, further comprising: A first inline static mixing chamber fluidly connected downstream of the first mixing manifold.

17. The continuous liquid blending system of claim 15, further comprising:
a. A modular control station structure comprising:
i. A first elongated member mounted to the station;
1. The first flow regulating valve mounted to the elongated horizontal member
2. The second flow regulating valve mounted to the elongated horizontal member;
ii. A second elongated member mounted to the station;
1. The first flow meter mounted to the second elongated member;
2. The second flow meter mounted to the second elongated member.
